(19) United States
(12) Patent Application Publication
(10) Pub. No.: US 2006/0294278 A1
(43) Pub. Date: Dec. 28, 2006

(54) COMPUTER SERVER

(75) Inventors: Fa-Da Lin, Taoyuan (TW); Hsiao-Tsu Ni, Taoyuan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: QUANTA COMPUTER INC., Tao Yuan Shien (TW)

(21) Appl. No.: 11/420,026

(22) Filed: May 24, 2006

(30) Foreign Application Priority Data
Jun. 28, 2005 (TW) 94121577

(51) Int. Cl. G06F 13/00

(52) U.S. Cl. 710/300

(57) ABSTRACT

A computer server. A computer server includes a motherboard, a hard disk, a first expansion card, and a second expansion card. The motherboard includes a central processing unit, a first interface, a second interface, and a third interface. The hard disk is electrically connected to the motherboard. The first expansion card is connected to the motherboard through the first interface, wherein data transmission between the hard disk and the motherboard can be decoded by utilizing the first expansion card. The second expansion card is connected to the motherboard through the second interface, wherein data transmission between the hard disk and the motherboard can be decoded by utilizing the second expansion card, and the hard disk is connected to the second expansion card via the first interface or the third expansion card.

### BACKGROUND OF THE INVENTION

1. Field of the Invention

The invention relates to a computer server, and in particular, to the computer server simultaneously supporting both SAS (Serial Attached SCSI) interface and SATA (Serial Advanced Technology Attachment) interface.

2. Description of the Related Art

When selecting data storage hard disks on a conventional computer server, the main connecting technique of majority storage system is parallel bus interface. IDE (Intelligent Drive Electronics) [also can be called ATA (Advanced Technology Attachment)] is generally utilized for parallel bus interface. After, the hard disk with faster transmission SCSI (Small Computer System Interface) is used. Faster, more accurate, and more reliable system is needed to achieve high-effect and cost-benefit for data storage requirements and improvement of the technology. Thus, SATA (Serial Advanced Technology Attachment) technique, which is different from Parallel ATA, has been developed. The advantage of SATA is a shorter transmission line, lower voltage, increased maximum length, and better heat dissipation. Moreover, the transmission speed of SATA can reach 600 MPS. Additionally, due to limited space in servers, in particular a Blade server, a SAS (Serial Attached SCSI) interface with the advantage of SATA interface and SCSI interface has been introduced. Not only the SAS interface is based on the SCSI interface but also can be compatible with SATA. Further, SAS interface is a trend for future development as it has better bandwidth expansion capacity.

### BRIEF SUMMARY OF THE INVENTION

Computer servers supporting both SAS and SATA interface are provided. Accordingly, an exemplary embodiment of a computer server comprises a motherboard, a hard disk, a first expansion card, and a second expansion card. The motherboard has a central processing unit, a first interface, a second interface, and a third interface. The hard disk is electrically connected to the motherboard. The first expansion card is connected to the motherboard through the first interface, wherein data transmission between the hard disk and the motherboard can be decoded by utilizing the first expansion card. The second expansion card is connected to the motherboard through the second interface, wherein data transmission between the hard disk and the motherboard can be decoded by utilizing the second expansion card, and the hard disk is connected to the second expansion card via the first interface or the third expansion card.

Furthermore, the second expansion card is a SAS controller card and the hard disk is a SAS hard disk. The SAS controller card comprises a SAS controller, which is utilized to decode the data. The first expansion card is a SAS signal strengthening card and the hard disk is a SATA hard disk.

Additionally, the second expansion card is a PCI expansion card or a PCI-Express card. The PCI expansion card or a PCI-Express card is inserted into the second expansion card. The first interface is a SATA transmission interface. The second interface is a PCI transmission interface or PCI-Express transmission interface. The third interface is a SAS transmission interface. The computer server further comprises an expansion hard disk, wherein the expansion hard disk is a SAS hard disk or a SATA hard disk.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of an embodiment of a computer server;

FIG. 2A is a block diagram of a first embodiment utilizing an expansion card;

FIG. 2B is a block diagram of a second embodiment utilizing an expansion card;

FIG. 3 is a side view of a third embodiment utilizing an expansion card; and

FIG. 4 is a flow chart of an embodiment utilizing the computer server.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

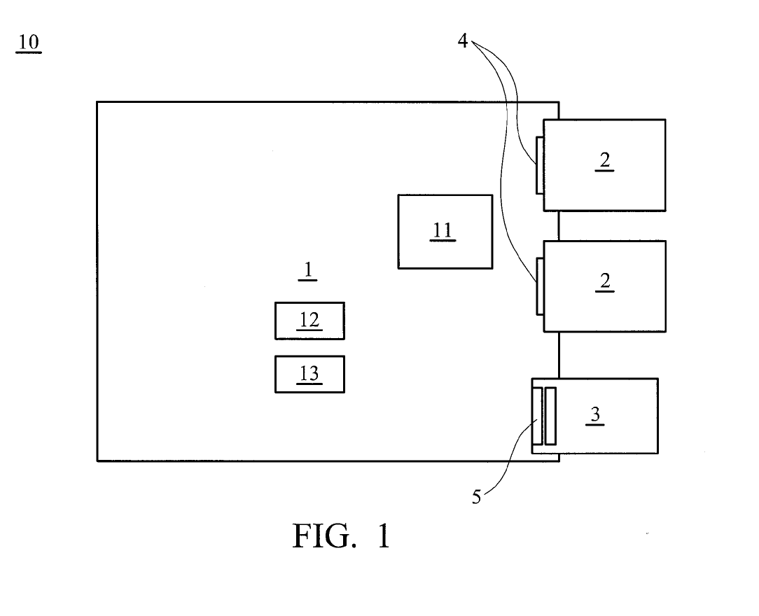

First, referring to FIG. 1, FIG. 1 is a schematic view of an embodiment of a computer server. As shown in FIG. 1, an embodiment of a computer server 10 comprises a motherboard 1, two hard disks 2, an expansion card 3, a first connection device 5, a second connection device 4, a first interface (SATA interface)(not shown), a second interface (PCI-Express interface)(not shown), and a third interface (SAS interface)(not shown). The motherboard 1 is a conventional motherboard applied to servers. The motherboard 1 comprises a central processing unit 11, a north bridge 12, and a south bridge 13. The expansion card 3 is connected to the motherboard 1 via the first connection device 5. Different transmission controller card is selected for different assembly requirements, such as SAS controller cards, SATA transmission cards, SATA signal strengthening cards, PCI expansion cards, or PCI-Express cards. Additionally, in practice, the first interface can be a SAS transmission interface or a SATA transmission interface, and the second interface can be a PCI transmission interface or a PCI-Express transmission card of depending on user's requirements. Furthermore, two hard disks 2 are connected to the motherboard 1 via the second connection device 4 and can cooperate with different expansion card 3 to apply SATA/SAS hard disks, practical operation is described afterward.

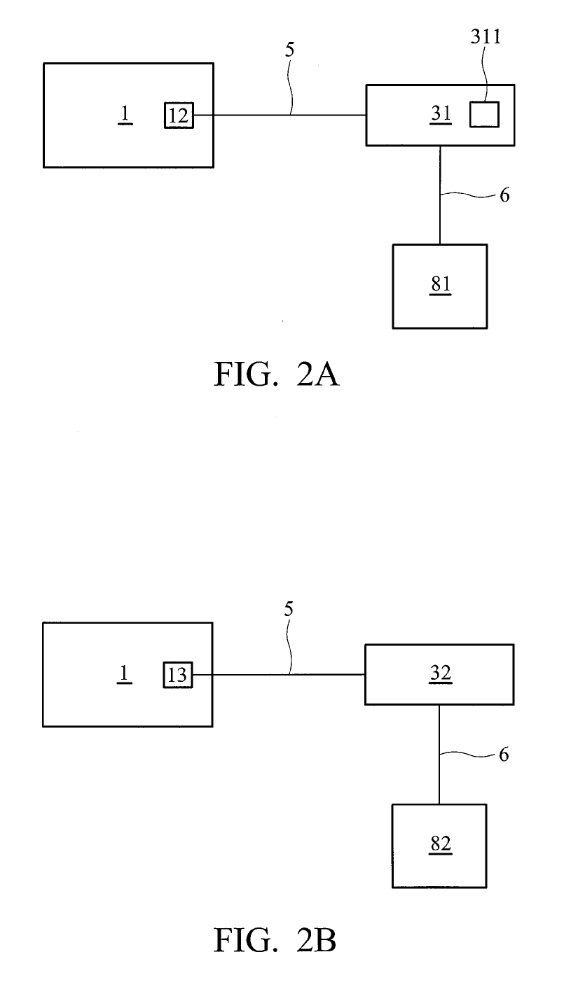

Secondly, referring to FIG. 1 and FIG. 2A, FIG. 2A is a block diagram of a first embodiment utilizing an expansion card. The expansion card 3 is a SAS controller card 31 in the embodiment of FIG. 1. The SAS controller card 31 is connected to the motherboard 1 via the second expansion card (PCI-Express interface) of the first connection device 5. Because the conventional server does not comprise SAS controller, data is transmitted to the SAS controller card 31 through the north bridge 12 and via the second interface. Then data is transmitted via the SAS controller 311 of the SAS controller card 31. When data is transmitted from the SAS hard disk 81 to the motherboard 1, data can be decoded. Equally, data which is stored in the SAS hard disk 81 is also transformed by the SAS controller 311 of the SAS controller card 31, and thereafter data can be transmitted to the motherboard 1 to be processed. In practice, the transmission interface of the SAS hard disk and the SATA hard disk are highly compatible. Thus, the hard disk in the embodiment can also be SATA hard disk. Additionally, the second interface can be the PCI transmission interface or the PCI-Express transmission interface with higher quality, depending on requirements. Furthermore, the additional expansion hard disk 81 can be added to the SAS controller card 31 via a third connection device 6. The first interface (SATA transmission interface) or the third interface (SATA transmission interface) can be disposed in the third connection device 6. The expansion hard disk 81 can be a SAS hard disk or a SATA hard disk.

Referring to FIG. 1 and FIG. 2B, FIG. 2B is a block diagram of a second embodiment utilizing an expansion card. The expansion card 3 in FIG. 1 is a SATA signal strengthening card 32. The SATA signal strengthening card 32 is connected to the motherboard 1 via the first interface (SATA interface) to transmit the data. In practice, the SATA controller is disposed on all conventional motherboards. Thus, data signal on the south bridge 13 of the motherboard 1 is transmitted to the SATA signal strengthening card 32, the data signal is then strengthened by the SATA signal strengthening card 32. At last, data signal is transmitted to the SATA hard disk 2 to be stored. Note that the SATA signal strengthening card 32 is applied to strengthen the signal to meet the requirements of SATA transmission distance in this embodiment. The motherboard 1 can be configured for use with only the SATA transmission card. Preferably, an additional expansion hard disk 82 can be added in the SATA signal strengthening card 32 via the third connection device 6, wherein the first interface is disposed in the third connection device 6, for example, a SATA transmission interface, and the expansion hard disk 82 is a SATA hard disk.

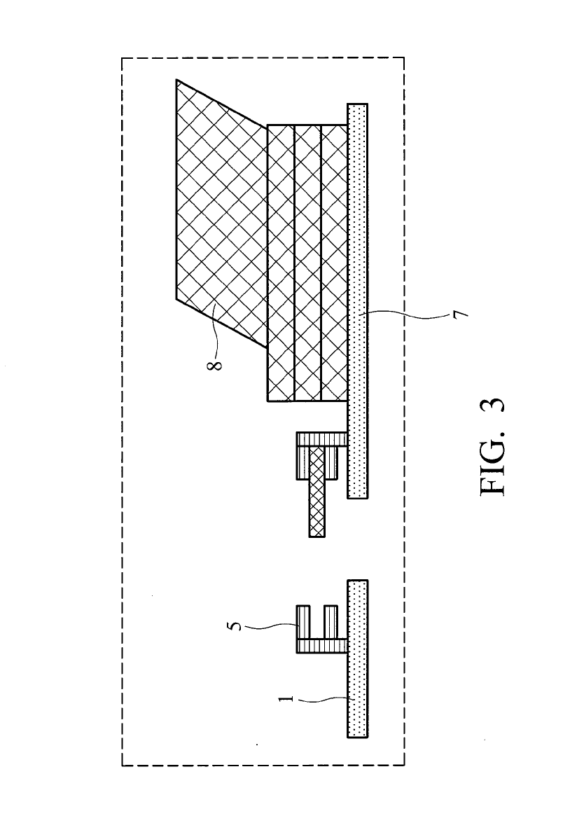

Referring to FIG. 3, FIG. 3 is a side view of a third embodiment utilizing an expansion card. The motherboard 1 is at the left side and the expansion card 3 is at right side. The expansion card 3 in this embodiment also can be a PCI riser card 7 for drawing. A first connection device 5 is disposed on the motherboard 1. That is, the first connection device 5 is a fixed groove which can connect with the motherboard 1 and the PCI expansion card 7 as a transmission interface to provide data transmitting. Furthermore, as shown in FIG. 3, the PCI expansion card 7 further comprises a PCI card 8 inserted therein. Note that the PCI-Express card can substitute for the PCI expansion card and the transmission interface of the first connection device 5 can be the second interface, for example, a PCI or PCI-Express interface. Thus, the PCI-Express bus flat with higher transmit bandwidth and quality is applied.

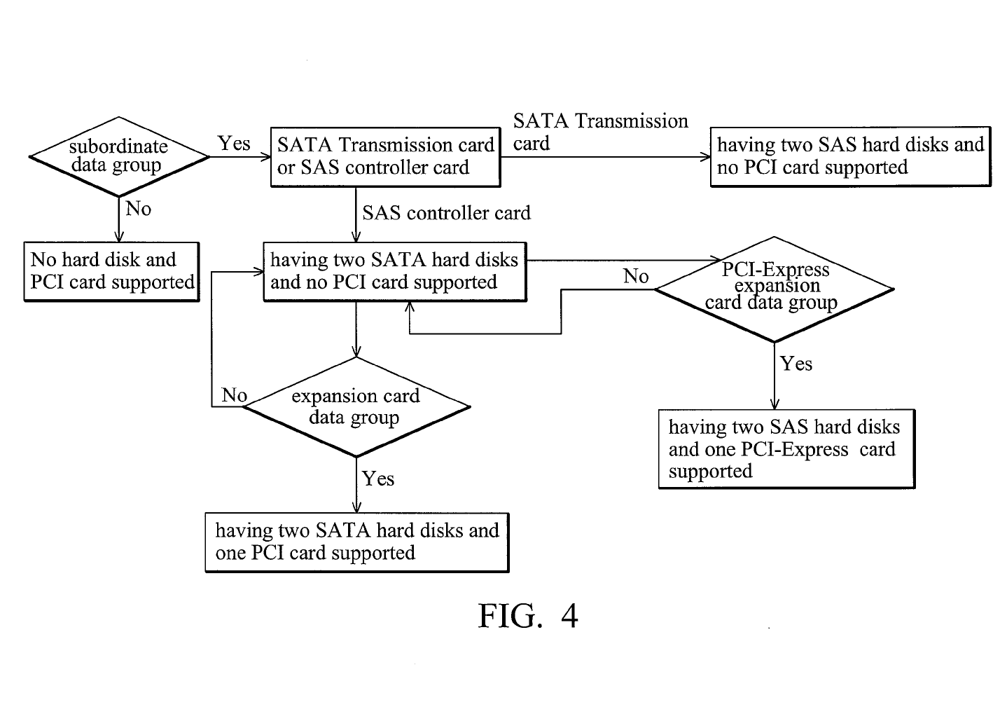

FIG. 4 is a flowchart of an embodiment utilizing the computer server. The flowchart shows that the computer server can employ various equipments when the computer server is used. For example, the data group can select a SATA hard disk or a SAS hard disk in advance and cooperate via a SATA transmission card or SAS controller card. In addition, user can further select the transmission interface, such as PCI or PCI-Express card, to improve the capability of the entire system.

In conclusion, the invention provides a computer server employing an expansion card. The invention can not only provide SAS/SATA hard disks with better transmission quality and bandwidth, but can also be applied a PCI/PCI-Express bus flat with higher transmission bandwidth.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A computer server, comprising:
a motherboard comprising a central processing unit, a first interface, a second interface, and a third interface;
a hard disk electrically connected to the motherboard;
a first expansion card connected to the motherboard through the first interface, wherein data transmission between the hard disk and the motherboard can be decoded by utilizing the first expansion card; and
a second expansion card connected to the motherboard through the second interface, wherein data transmission between the hard disk and the motherboard can be decoded by utilizing the second expansion card, and the hard disk is connected to the second expansion card via the first interface or the third expansion card.

2. The computer server as claimed in claim 1, wherein the second expansion card is a Serial Attached SCSI (SAS) controller card.

3. The computer server as claimed in claim 2, wherein the hard disk is a SAS hard disk.

4. The computer server as claimed in claim 2, wherein the hard disk is a SATA hard disk.

5. The computer server as claimed in claim 2, wherein the SAS controller card comprises a SAS controller, the SAS controller is utilized to decode the data.

6. The computer server as claimed in claim 1, wherein the first expansion card is a SATA signal strengthening card.

7. The computer server as claimed in claim 1, wherein the second expansion card is a Peripheral Component Interconnect (PCI) expansion card or a PCI-Express expansion card.

8. The computer server as claimed in claim 7, further comprising a PCI card or a PCI-Express card inserted into the second expansion card.

9. The computer server as claimed in claim 1, wherein the first interface is a SATA transmission interface.

10. The computer server as claimed in claim 1, wherein the second interface is a PCI transmission interface or a PCI-Express transmission interface.

11. The computer server as claimed in claim 1, wherein the third interface is a SAS transmission interface.

12. The computer server as claimed in claim 11, further comprising an expansion hard disk, wherein the expansion hard disk is a SAS hard disk or a SATA hard disk.
